(19) United States
(12) Patent Application Publication
(10) Pub. No.: US 2025/0199264 A1
(43) Pub. Date: Jun. 19, 2025

(54) OPTICAL APPARATUS, IMAGING APPARATUS, CONTROL SYSTEM, AND MOVABLE APPARATUS

(71) Applicant: CANON KABUSHIKI KAISHA, Tokyo (JP)

(72) Inventors: AYUMU KAMEOKA, Saitama (JP); AKIHIRO OTANI, Tochigi (JP)

(21) Appl. No.: 18/974,512

(22) Filed: Dec. 9, 2024

(30) Foreign Application Priority Data
Dec. 13, 2023 (JP) 2023-210349

(51) Int. Cl. G02B 7/02; G03B 30/00

(52) U.S. Cl. CPC G02B 7/028; G02B 7/026; G03B 30/00

(57) ABSTRACT

An optical apparatus that enables a decrease in size while decreasing a backlash or a tightening quantity between a pressing member and a lens is provided. The optical apparatus includes a barrel member that holds an optical element, a pressing member that contacts with both the optical element and the barrel member, a biased member that is fixed to the barrel member, and an elastic member that is disposed between the pressing member and the biased member in a radial direction and interposed between the biased member and the pressing member in an optical axis direction.

### BACKGROUND

### Technical Field

The present disclosure relates to an optical apparatus, an imaging apparatus, a control system, and a movable apparatus.

### Description of the Related Art

An example of an optical apparatus that is mounted in an automobile is a camera that is used in sensing for a driving support function or an automatic driving function and images the surroundings of the automobile. A Light Detection And Ranging (LiDAR) apparatus is known as an optical apparatus having a sensing function. Guaranteeing of excellent performance and functions in the whole temperature range of a temperature environment that varies in a wide range is required for an onboard camera or a LiDAR apparatus.

### SUMMARY

An optical apparatus according to an aspect of embodiments of the present disclosure includes: a barrel member that holds an optical element; a pressing member that contacts with both the optical element and the barrel member; a biased member that is fixed to the barrel member; and an elastic member that is disposed between the pressing member and the biased member in a radial direction and interposed between the biased member and the pressing member in an optical axis direction.

Further features of the present disclosure will become apparent from the following description of exemplary embodiments with reference to the attached drawings.

### BRIEF DESCRIPTION OF THE DRAWINGS

FIG. 1 is a diagram illustrating an optical apparatus according to a first embodiment.

FIG. 2 is a sectional view of a structure of an optical unit according to the first embodiment.

FIG. 3 is a sectional view of a structure of an optical unit according to a second embodiment.

FIG. 4 is a sectional view of a structure of an optical unit according to the related art.

FIG. 5 is a diagram illustrating a configuration of an onboard system according to a third embodiment.

FIG. 6 is a diagram schematically illustrating a vehicle, which is a movable apparatus, including the onboard system according to the third embodiment.

FIG. 7 is a flowchart illustrating an example of operations of the onboard system according to the third embodiment.

### DESCRIPTION OF THE EMBODIMENTS

Hereinafter, embodiments of the present disclosure will be described in detail with reference to the accompanying drawings. The following embodiments are examples of a realization means of the present disclosure, configurations or various conditions of apparatuses to which the present disclosure is applied can be appropriately modified or altered, and the present disclosure is not limited to the following embodiments.

A main type of an example of an optical apparatus that is mounted in an automobile is a fixed focus type not including an automatic focusing mechanism in view of costs and reliability not to cause a failure. Onboard cameras have a function of monitoring in front, the vicinity, and behind a vehicle and generally need to have a wide viewing angle in order to acquire a lot of information using one camera for the purpose of space saving.

Here, when an optical system of such an apparatus increases in complexity and functionality, it can be assumed that the number of optical elements will increase and a backlash or tightening between a pressing member, a barrel member (lens barrel), and lenses which are optical elements which occur due to a change in temperature will become even greater. That is, when lenses are held by a barrel member and ambient temperature changes based on a difference in expansion/contraction due to a difference in linear expansion coefficient between the lenses and the barrel member, there is a likelihood that a backlash or tightening will be generated in an optical axis direction. A change in held position due to the generated backlash or surface deformation of the lenses due to the tightening may cause aging of optical performance or aging of components. In order to avoid this, a flange is provided in the barrel member and a biased member screwed to the pressing member for pressing a lens closest to an object is provided on a surface on an imaging surface side of the flange. A configuration has been adopted in which an elastic member such as a wave washer is provided between the flange and the biased member. Accordingly, by deforming the elastic member by a necessary quantity in advance at the time of assembly at normal temperature to generate an elastic force, the backlash or the tightening quantity is decreased.

On the other hand, since a focus of a fixed focus type camera such as an onboard camera cannot be adjusted at the time of use, adjustment for curbing partial blurring has to be performed before shipment. An optical adjustment method called “tilt adjustment” of aligning a slope of an image forming surface of the optical system with the slopes of imaging surface of the image sensors by adjusting slopes of image sensors with respect to an optical axis of the optical system in a pitch direction and a yaw direction has been proposed. A barrel member in which lenses are mounted is fixed to an adjustment tool, and an evaluation chart disposed to be separated by a design gap from an imaging apparatus is imaged by the imaging apparatus. Resolutions or contrast values at four corners of the periphery of the captured image of the evaluation sheet are ascertained, and tilt adjustment of the imaging device to a desired position is performed. After the tilt adjustment in the method, an adhesive is applied between another flange not in contact with the elastic member of the barrel member in which lenses are mounted and a sensor holder holding the imaging device to fix the flange and the sensor holder.

Accordingly, since the configuration is a configuration in which the elastic member is assembled from the imaging surface side, the inner diameter of the elastic member needs to be set to be larger than the outer diameter of the flange which is bonded and fixed to the sensor holder. As a result, the barrel member increases in size. In order to curb the increase in size, a configuration in which a leaf spring is provided in a pressing member holding lenses and a backlash in the optical axis direction due to a change in temperature is prevented by a pressing force of the leaf spring has been proposed as described as a method of assembling the elastic member from a subject side in Japanese Patent No. 5049220.

However, in the related art disclosed in Japanese Patent No. 5049220, the leaf spring has to have a length in the radial direction to give an elastic force to the leaf spring. When the elastic member is held between the pressing member and the lens, the elastic member is disposed at a position separated in the radial direction from an effective lens diameter in order to secure a viewing angle. That is, the pressing member has a large dimension in the radial direction.

A camera with a wide viewing angle is likely to have a lens closest to a subject with a large size in the radial direction. When the pressing member also needs to have a large dimension in the radial direction, the diameter of the barrel member unit including the pressing member is likely to increase. When the diameter of the barrel member unit on the subject side increases and an installation height is defined at the time of installing a camera close to a front windshield tilted from the front to the rear of a vehicle body, the camera as a whole is disposed on the rear side, and thus an installation space is enlarged.

### First embodiment

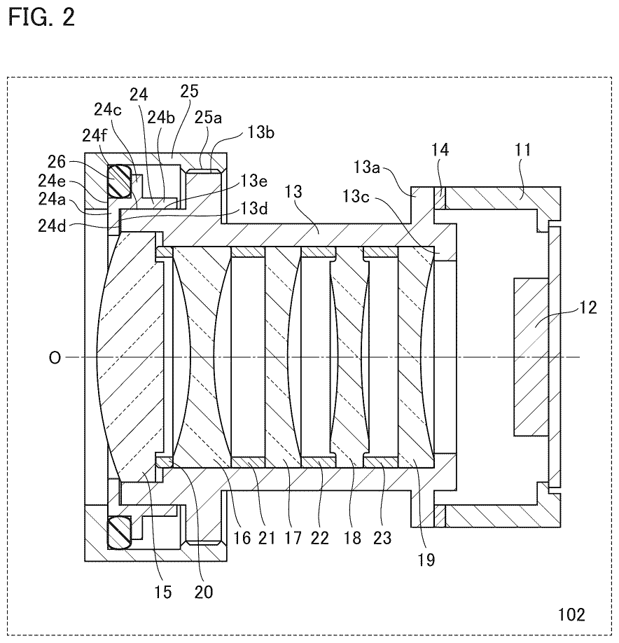

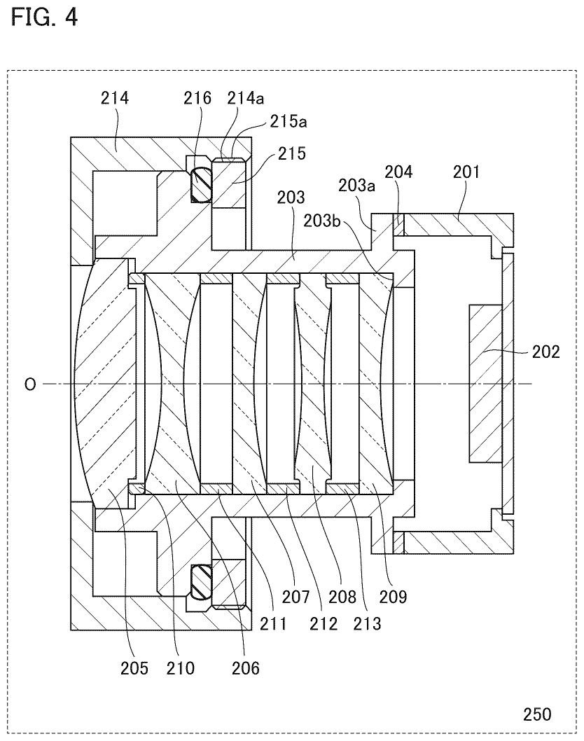

A structure of an optical unit according to the related art illustrated in FIG. 4 will be first described, and then an optical unit 102 according to a first embodiment illustrated in FIG. 2 will be described. FIG. 4 is a sectional view of a structure of an optical unit 250 according to the related art.

The optical unit 250 is an example of an optical unit provided in an optical apparatus according to the related art. A sensor holder 201 fixes and holds an imaging device 202. A barrel member 203 houses a plurality of lenses that will be described later. The barrel member 203, in which a plurality of lenses is housed, is aligned with the sensor holder 201 in which the imaging device 202 is held, and an adhesive 204 is applied between a flange 203a of the barrel member 203 and the sensor holder 201 to fix them. In the barrel member 203, a first lens 205, a second lens 206, a third lens 207, a fourth lens 208, and a fifth lens 209 are sequentially arranged from a subject side (the left side in FIG. 4).

A first spacer 210 is disposed between the first lens 205 and the second lens 206. A second spacer 211 is disposed between the second lens 206 and the third lens 207. A third spacer 212 is disposed between the third lens 207 and the fourth lens 208. A fourth spacer 213 is disposed between the fourth lens 208 and the fifth lens 209.

A pressing member 214, a biased member 215, and an elastic member 216 are provided to come into contact with the first lens 205 and to hold the first lens in the barrel member 203.

The optical unit 250 houses and holds the first lens 205, the second lens 206, the third lens 207, the fourth lens 208, and the fifth lens 209 in the barrel member 203. In addition, the optical unit 250 houses and holds the first spacer 210, the second spacer 211, the third spacer 212, and the fourth spacer 213 in the barrel member 203.

In a state in which the lenses and the spacers are housed and held, the elastic member 216 is disposed from an imaging surface side (the right side in FIG. 4). After the elastic member 216 has been disposed, the biased member 215 is similarly inserted from the imaging surface side. Finally, a female screw portion 214a of the pressing member 214 and a male screw portion 215a of the biased member 215 are screwed to each other such that the pressing member 214 comes into contact with the first lens 205, and thus the lenses are fixed in a direction of an optical axis O in a state in which the biased member 215 is compressed. By holding the lenses with the pressing member 214 in a state in which the elastic member 216 is compressed by a necessary quantity, the first lens 205 is normally pressed to the pressing member 214 with a reaction force based on an elastic force of the elastic member 216.

Here, the inner diameter of the elastic member 216 should be set to be larger than the outer diameter of the flange 203a in order to avoid interference of the elastic member 216 with the flange 203a of the barrel member 203. Accordingly, there is a problem in that the outer diameter of the pressing member 214 is larger than the outer diameter of the flange 203a.

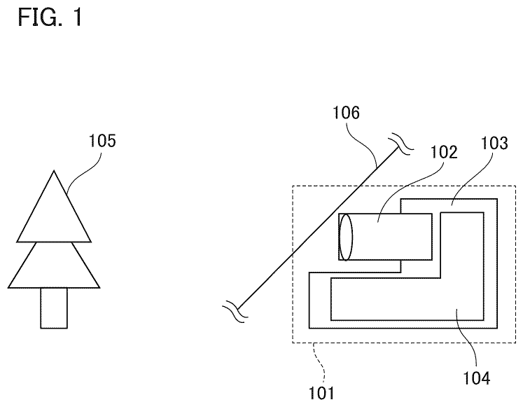

Exemplary embodiments of the present disclosure will be described below in detail with reference to the accompanying drawings. FIG. 1 is a diagram schematically illustrating an optical apparatus 101 according to the present embodiment.

The optical apparatus 101 includes an optical unit 102, a housing 103, and an electrical device 104. For example, when the optical apparatus 101 is an onboard camera, the optical unit 102 serves as an imaging optical system. When a subject 105 is imaged, a signal is input to the electrical device 104 including an image sensor, and thus surrounding environment information of an automobile is acquired.

The image sensor can be a CCD, a CMOS, or the like and converts light condensed and received via the optical unit 102 to an electrical signal. The converted electrical signal is converted to analog data or digital data, which is constituents of captured image data. The acquired data is used in a system for driving support or automated driving. A subject side of the optical unit 102 of the optical apparatus 101 such as an onboard camera may be exposed from the housing 103, and the optical unit 102 may be installed on a vehicle body in the vicinity of a front windshield 106. Since a decrease in size of an installation space is required for coming close to the front windshield 106 as much as possible, it is also preferable to decrease the size of the optical unit 102.

FIG. 2 is a sectional view of the structure of the optical unit 102 according to the present embodiment. An image sensor 12 is fixed to and held in a sensor holder 11. A barrel member 13 houses a plurality of lenses which will be described later. The barrel member 13 in which the plurality of lenses are housed is aligned with the sensor holder 11 in which the image sensor 12 is held, and an adhesive 14 is applied between a flange 13a of the barrel member 13 and the sensor holder 11 to fix them. Accordingly, the barrel member 13 and the sensor holder 11 can be fixed. In the barrel member 13, a first lens 15, a second lens 16, a third lens 17, a fourth lens 18, and a fifth lens 19 are sequentially arranged from the subject side (the left side in FIG. 2).

A first spacer 20 is disposed between the first lens 15 and the second lens 16. A second spacer 21 is disposed between the second lens 16 and the third lens 17. A third spacer 22 is disposed between the third lens 17 and the fourth lens 18. A fourth spacer 23 is disposed between the fourth lens 18 and the fifth lens 19.

In the present embodiment, a pressing member 24, a biased member 25, and an elastic member 26 are configured to come into contact with the first lens 15 and then hold the first lens 15 in the barrel member 13. The first lens 15, the second lens 16, the third lens 17, the fourth lens 18, and the fifth lens 19 in the present embodiment are glass lenses.

The barrel member 13, the first spacer 20, the second spacer 21, the third spacer 22, the pressing member 24, and the elastic member 26 are formed of a metallic material. The number of lenses or the number of spacers can be arbitrarily set according to applications thereof or the like. The materials and the like of the lenses, the spacers, and the barrel member can be arbitrarily set according to applications thereof. For example, the first lens 15 may be a spherical glass lens, and the second lens 16, the third lens 17, the fourth lens 18, and the fifth lens 19 may be resin lenses. For example, the pressing member 24 may be formed of a resin material.

An “aperture diaphragm” for limiting a transmitted light quantity and determining an F-value, serving as a brightness indicator, or a “light blocking diaphragm” for blocking light causing ghost or light causing an aberration may be provided in the optical unit 102. In the present embodiment, such an aperture diaphragm or such a light blocking diaphragm is not illustrated. According to necessity, an antireflection film, a hydrophilic film, a hydrophobic film, and the like are provided on the surfaces of the first lens 15, the second lens 16, the third lens 17, the fourth lens 18, and the fifth lens 19.

The pressing member 24 includes a short side portion 24a and a long side portion 24b, which is longer than the short side portion 24a in a direction perpendicular to the direction in which the short side portion 24a is formed. The pressing member 24 further includes a first protrusion (a protruding portion) 24c. The first protrusion 24c is formed to protrude in a direction opposite to the direction in which the short side portion 24a is formed from a part of the long side portion 24b. The pressing member 24 includes a contact surface 24d, which is a surface coming into contact with the first lens 15, and a contact surface 24e, which is a surface coming into contact with the biased member 25 on the short side portion 24a side. The pressing member 24 includes a contact surface 24f on a surface opposite to the side on which the first protrusion 24c is formed. The contact surface 24f is a surface in contact with a contact surface 13e of the barrel member 13 when the pressing member 24 is disposed with respect to the barrel member 13.

The elastic member 26 is formed of a rubber material such as silicone rubber or a metallic spring member such as a compression coil spring or a wave washer in consideration of heat resistance such that physical characteristics are not affected even in a harsh onboard temperature environment. The elastic member 26 is interposed and held between the pressing member 24 and the biased member 25 in a direction of the optical axis O. The optical axis O direction is the direction parallel to the optical axis of the optical apparatus 101, and is also a direction from the object side (subject side) to the imaging surface side. The optical axis O of the optical apparatus 101 is the axis passing through the apex of each optical surface in the optical system in the optical apparatus 101.

A method of assembling the optical unit 102 will be described below. The method of assembling the optical unit 102 in a state in which the first lens 15, the second lens 16, the third lens 17, the fourth lens 18, and the fifth lens 19 are housed and held in the barrel member 13 of the optical unit 102 will be described. It is assumed that the first spacer 20, the second spacer 21, the third spacer 22, and the fourth spacer 23 are housed and held in the barrel member 13.

In a state in which the lenses and the spacers are housed and held, the pressing member 24 is assembled into the barrel member 13 from the subject side. At the time of assembling the pressing member 24, the contact surface 24d of the pressing member 24 comes into contact with the first lens 15. When the contact surface 24d of the pressing member 24 comes into contact with the first lens 15, the contact surface 24d of the pressing member 24 is separated from the surface 13d of the barrel member 13 in the direction of the optical axis O. When the pressing member 24 is brought into contact with the barrel member 13 and the first lens 15 as illustrated in FIG. 2, the short side portion 24a, which is a part on the subject side of the pressing member 24, is located outside of the barrel member 13 in the direction of the optical axis O.

When the pressing member 24 is disposed in the barrel member 13, the first protrusion 24c of the pressing member 24 protrudes outward in the radial direction. When the pressing member 24 is disposed in the barrel member 13, the contact surface 24f of the pressing member 24 also comes into contact with the contact surface 13e of the barrel member 13. The radial direction is orthogonal to the optical axis O direction and is also the direction from the center of each optical surface to the periphery.

Then, the elastic member 26 is inserted from the subject side. The elastic member 26 can be disposed in the pressing member 24 in the insertion step.

Finally, the biased member 25 is disposed with respect to the barrel member 13 in a state in which the pressing member 24 and the elastic member 26 are disposed, and the biased member 25 is fixed to the barrel member 13. At this time, a male screw portion 13b on an outer radial portion of the barrel member 13 is screwed into a female screw portion 25a on an inner radial portion of the biased member 25 in a state in which an inner surface of the biased member 25 in the direction of the optical axis O is in contact with the contact surface 24e, which is a surface on the subject side (an outer surface) of the pressing member 24. Accordingly, the elastic member 26 is interposed between the biased member 25 and the pressing member 24 in the direction of the optical axis O. Specifically, when the biased member 25 is disposed in the barrel member 13, the elastic member 26 disposed between the biased member 25 and the first protrusion 24c of the pressing member 24 in the direction of the optical axis O is in a compressed state. Then, by fixing the biased member 25 to the barrel member 13 in the state in which the elastic member 26 is compressed, the first lens 15 can be fixed in the direction of the optical axis O.

In this way, the pressing member 24 is disposed in the barrel member 13, then the elastic member 26 is disposed in the pressing member 24, and finally the biased member 25 is fixed to the barrel member 13. Accordingly, the elastic member 26 is located between the biased member 25 and the first protrusion 24c of the pressing member 24 in the direction of the optical axis O and is located between the pressing member 24 and the biased member 25 in a direction (the radial direction) perpendicular to the direction of the optical axis O.

In this way, when the pressing member 24 is disposed in the barrel member 13, then the elastic member 26 is disposed in the pressing member 24, and finally the biased member 25 is fixed to the barrel member 13, the first protrusion 24c of the pressing member 24 is located inside of the biased member 25 in the direction of the optical axis O and the radial direction. Even when the biased member 25 is fixed to the barrel member 13 after the pressing member 24 and the elastic member 26 have been disposed, the first protrusion 24c of the pressing member 24 does not come into contact with the biased member 25.

When the biased member 25 is fixed to the barrel member 13 after the pressing member 24 and the elastic member 26 have been disposed, the biased member 25 includes a first area, which is an area outside of the barrel member 13 in the direction of the optical axis O, and a second area which is an area outside of the barrel member 13 in the radial direction. By employing the structure of the optical unit 102 according to the present embodiment, the inner diameter of the elastic member 26 can be set to be equal to or less than the outer diameter of the flange 13a.

By holding the first lens 15 with the pressing member 24 in a state in which the elastic member 26 is compressed by a necessary quantity, the first lens 15 is normally compressed by the pressing member 24 with a reaction force due to an elastic force of the elastic member 26.

By causing the pressing member 24 to normally press the first lens 15 with a reaction force due to the elastic force of the elastic member 26, lens deformation due to tightening generated from a difference in linear expansion coefficient between the barrel member 13 and the lens when the ambient temperature is low at the time of assembly can be absorbed by the elastic member 26.

In the present embodiment, the barrel member 13, the pressing member 24, the first spacer 20, the second spacer 21, the third spacer 22, and the fourth spacer 23 are formed of an aluminum alloy, and a linear expansion coefficient thereof is 26×10\hat{ }−6/° C.

The first lens 15, the second lens 16, the third lens 17, the fourth lens 18, and the fifth lens 19 are formed of glass, and a linear expansion coefficient is 7×10\hat{ }−6/° C.

Here, it is assumed that the length in the optical axis direction of the first lens 15 is 3 mm and the length in the optical axis direction of the second lens 16 is 5 mm. It is assumed that the lengths in the optical axis direction of the third lens 17 and the fifth lens 19 are 3 mm. It is assumed that the length in the optical axis direction of the fourth lens 18 is 2.5 mm. It is assumed that the length in the optical axis direction of the first spacer 20 is 1.5 mm. It is assumed that the lengths in the optical axis direction of the second spacer 21, the third spacer 22, and the fourth spacer 23 are 3 mm. It is assumed that the length in the optical axis direction from a wall 13c of the barrel member 13 to a contact portion between the pressing member 24 and the first lens 15 is 27 mm. At this time, when the temperature changes by 1° C., a gap of about 0.3 μm is generated between the barrel member and the lens.

In an environment in which the outside air temperature is lower by 60° C. than at the time of assembly, lens deformation of about 18.8 μm in the direction in which the lenses are compressed is likely to occur in the optical axis direction, but this deformation can be absorbed by the elastic member 26.

On the other hand, in an environment in which the outside air temperature is higher by 60° C. than at the time of assembly, a backlash of about 19.4 μm occurs in the optical axis direction. However, since the elastic member 26 is compressed, the pressing member 24 normally presses and holds the first lens 15 with a reaction force due to the elastic force of the elastic member 26, and thus the backlash can be absorbed.

With the structure of the optical unit 102 according to the present embodiment, since the elastic member 26 can be inserted from the subject side, it is possible to set the inner diameter of the elastic member 26 to be equal to or less than the outer diameter of the flange 13a of the barrel member 13. Accordingly, since constraints in which the inner diameter of the elastic member 26 is larger than the outer diameter of the flange 13a of the barrel member 13 do not need to be considered unlike the related art, it is possible to decrease the size of the optical apparatus 101.

### Second embodiment

A structure for preventing generation of torsion of an elastic member provided between a biased member and a pressing member will be described below as a second embodiment. When an elastic member is disposed between the biased member and the pressing member, torsion may be generated in the elastic member due to contact resistance between the biased member and the pressing member. Accordingly, a biasing force applied to the lens may be non-uniform, and it may not be possible to reduce a backlash or tightening occurring between the pressing member and the lens. As a result, there is required for a structure that can curb torsion of the elastic member.

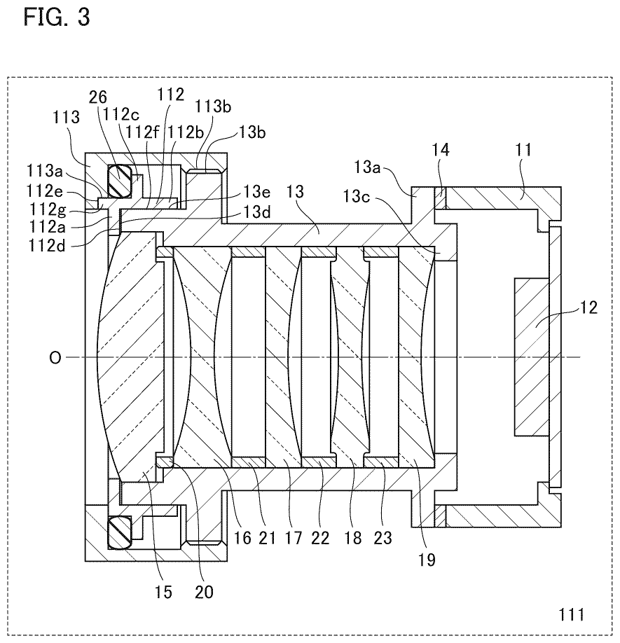

FIG. 3 is a sectional view of a structure of an optical unit 111 according to the second embodiment. Description of the same structure, assembly method, and the like in an optical apparatus according to the second embodiment as in the optical apparatus 101 according to the first embodiment will be omitted.

The pressing member 112 in the second embodiment includes a short side portion 112a and a long side portion 112b, which is longer than the short side portion 112a in a direction perpendicular to a direction in which the short side portion 112a is formed. The pressing member 112 includes a first protrusion (protruding portion) 112c. The first protrusion 112c is formed to protrude in a direction opposite to the direction in which the short side portion 112a is formed from a part of the long side portion 112b. The pressing member 112 includes a contact surface 112d, which is a surface coming into contact with the first lens 15, and a contact surface 112e which is a surface coming into contact with the biased member 113 on the short side portion 112a side. The pressing member 112 includes a contact surface 112f on the surface opposite to the side on which the first protrusion 112c is formed. The contact surface 112f is a surface coming into contact with the contact surface 13e of the barrel member 13 when the pressing member 112 is disposed in the barrel member 13. A second protrusion (a rotation regulating portion) 112g for regulating rotation is provided in the pressing member 112 in the second embodiment.

In the second embodiment, by fixing the biased member 113 to the barrel member 13 after having disposed the pressing member 112 and the elastic member 26, the elastic member 26 is interposed and held between the pressing member 112 and the biased member 113 in the direction of the optical axis O. Specifically, similarly to the first embodiment, the pressing member 112 is disposed in the barrel member 13, then the elastic member 26 is disposed in the pressing member 112, and finally the biased member 113 is fixed to the barrel member 13. Accordingly, the elastic member 26 is located between the biased member 113 and the first protrusion 112c of the pressing member 112 in the direction of the optical axis O and is located between the pressing member 112 and the biased member 113 in the direction (the radial direction) perpendicular to the direction of the optical axis O.

In the second embodiment, when the biased member 113 is disposed in a state in which the pressing member 112 and the elastic member 26 have been disposed, the second protrusion 112g provided in the pressing member 112 is inserted into a groove 113a formed on the inner radial portion of the biased member 113. That is, the second protrusion 112g is fitted into the groove 113a. Accordingly, rotation of the pressing member 112 around the optical axis is regulated. Then, by screwing the male screw portion 13b of the barrel member 13 into the female screw portion 113b of the biased member 113 in a state in which the second protrusion 112g has been fitted into the groove 113a, the biased member 113 and the barrel member 13 are fixed. At this time, with the configuration according to the second embodiment, the elastic member 26 can be compressed without torsion when the male screw portion 13b of the barrel member 13 is screwed into the female screw portion 113b of the biased member 113.

Accordingly, similarly to the first embodiment, since a decrease in size of the optical apparatus is possible and the elastic member 26 can be compressed without torsion, it is possible to reduce a backlash or a tightening quantity between the pressing member and the lens which is generated due to a change in temperature.

### Third embodiment

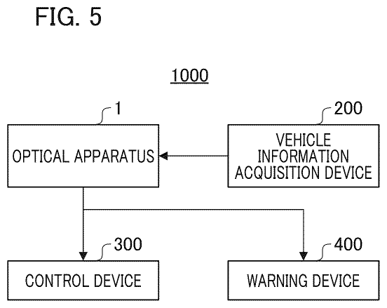

FIG. 5 is a diagram illustrating configuration of the optical apparatuses according to the embodiments and an onboard system (a driving support system) 1000 including the optical apparatuses. An optical apparatus 1 according to a third embodiment has the configurations of the optical apparatuses according to the first embodiment and the second embodiment.

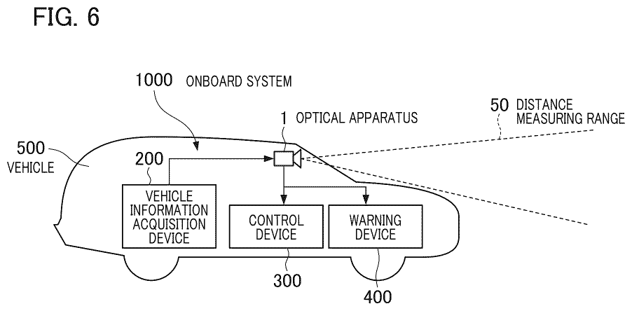

The onboard system 1000 is a control system that is held by a movable object (a movable apparatus) that is movable, such as an automobile (a vehicle), and supports driving (control) of a vehicle 500 on the basis of distance information of an object such as an obstacle or a pedestrian near the vehicle acquired by the optical apparatus 1. FIG. 6 is a diagram schematically illustrating a vehicle 500 which is a movable apparatus including the onboard system 1000. In FIG. 6, a distance measuring range (a detection range) of the optical apparatus 1 is set forward from the vehicle 500, but the distance measuring range may be set rearward or laterally from the vehicle 500.

As illustrated in FIG. 6, the onboard system 1000 includes an optical apparatus 1, a vehicle information acquisition device 200, a control device (a control unit (an electronic control unit (ECU)) 300, and a warning device (a warning unit) 400. In the onboard system 1000, a control unit (not illustrated) provided in the optical apparatus 1 has functions of a distance acquiring unit (an acquisition unit) and a collision determining unit (a determination unit). According to necessity, a distance acquiring unit or a collision determining unit which is separate from the control unit in the onboard system 1000 may be provided, or the units may be provided outside of the optical apparatus 1 (for example, inside of the vehicle 500). Alternatively, the control device 300 may be used as the control unit. The optical apparatus 1 may include a scanning unit configured to scan an object using illumination light from a light source (not illustrated).

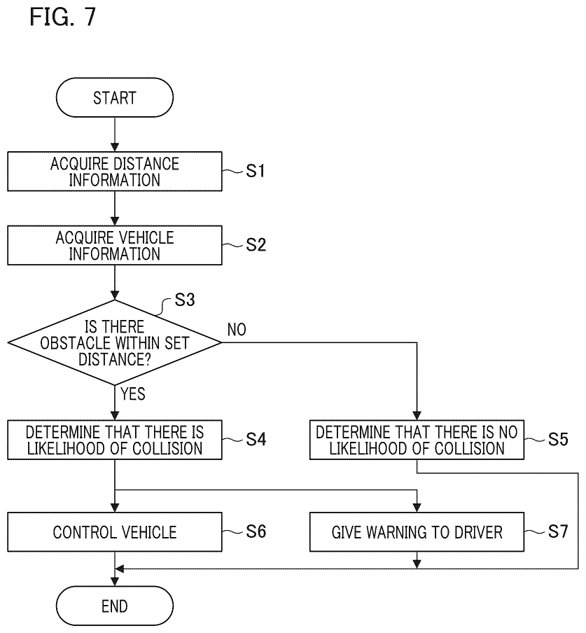

FIG. 7 is a flowchart illustrating an example of operations of the onboard system 1000 according to the third embodiment. The operations of the onboard system 1000 will be described below with reference to this flowchart.

First, in Step S1, an object near the vehicle 500 is illuminated with illumination light from the light source of the optical apparatus 1, and reflected light from the object is received. The control unit acquires distance information of the object on the basis of a signal that is output from a light receiving element (a light receiving unit), which is not illustrated, by receiving reflected light via the lenses. Here, the distance information has only to be information on a distance from the movable apparatus (the vehicle 500) to the object and may not be a distance itself. In Step S2, vehicle information including a vehicle speed, a yaw rate, a steering angle, and the like of the vehicle 500 is acquired by the vehicle information acquisition device 200. Then, in Step S3, the control unit determines whether the distance to the object is included in a preset range of a set distance using the distance information acquired in Step S1 or the vehicle information acquired in Step S2.

Accordingly, it is possible to determine whether an object is present within the set distance near the vehicle 500 and to determine a likelihood of collision of the object with the vehicle 500. Steps S1 and S2 may be performed in the reversed order of the aforementioned order or may be performed in parallel. The control unit determines that there is a “likelihood of collision” when an object is present within the set distance (Step S4) and determines that there is “no likelihood of collision” when an object is not present within the set distance (Step S5).

Then, when it is determined that there is a “likelihood of collision,” the control unit notifies the control device 300 or the warning device 400 of the determination result (transmits the determination result thereto). At this time, the control device 300 controls the vehicle 500 on the basis of the determination result from the control unit (Step S6), and the warning device 400 gives a warning to a user (a driver or an occupant) of the vehicle 500 on the basis of the determination result from the control unit (Step S7). That is, the warning device 400 gives a warning on the basis of the distance of the object. Notification of the determination result may be performed on at least one of the control device 300 and the warning device 400.

The control device 300 can control driving and movement of the vehicle 500 by outputting a control signal to a driving unit (such as an engine or a motor) of the vehicle 500. For example, the control device 300 performs control for braking the vehicle 500, returning an accelerator, turning a steering wheel, generating a control signal for generating a braking force in each wheel to curb an output of an engine or a motor, or the like. The warning device 400 gives a warning to a user, for example, by giving a warning sound, displaying warning information on a screen of a car navigation system or the like, or applying vibration to a seat belt or a steering wheel.

With the onboard system 1000 according to the third embodiment, it is possible to perform detection of an object and measuring a distance thereto through the aforementioned processes and to avoid collision of the vehicle 500 with the object. Particularly, by applying the optical apparatuses according to the embodiments to the onboard system 1000, since high distance measuring accuracy can be realized, it is possible to perform detection of an object and determination of collision with high accuracy.

In the third embodiment, the onboard system 1000 is applied for driving support (reduction of collision damage), but the present disclosure is not limited thereto, and the onboard system 1000 may be applied for cruise control (which includes a full vehicle speed following functional unit), automated driving, or the like. The onboard system 1000 is not limited to a vehicle such as an automobile, but can be applied to a movable object such as a ship, an aircraft, or an industrial robot. In addition to a movable object, the onboard system 1000 can be applied to various apparatuses using object recognition such as an intelligent transport system (ITS) or a monitoring system.

The onboard system 1000 or the vehicle 500 may include a notification device (a notification unit) for notifying a manufacturer (a maker) of the onboard system or a seller (a dealer) of the movable apparatus when the vehicle 500 collides with an obstacle. For example, a device that transmits information on collision of the vehicle 500 with an obstacle (collision information) to a preset external notification destination using an electronic mail or the like can be employed as the notification device.

By employing the configuration for automatically notifying of collision information using the notification device in this way, it is possible to rapidly take measures such as checking or repairing after the collision has occurred. The notification destination of the collision information may be an insurance company, a medical institute, a police, or an arbitrary destination set by a user. In addition to collision information, the notification device may be configured to notify a notification destination of failure information of constituents or consumption information of expendables. Detection of collision may be performed using distance information acquired on the basis of an output from the aforementioned light receiving element or may be performed using another sensing unit (a sensor).

While the present disclosure has been described above in detail with reference of exemplary embodiments thereof, the present disclosure is not limited to the specific embodiments, and various modifications without departing from the gist of the present disclosure are included in the present disclosure. Parts of the aforementioned embodiments may be appropriately combined.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210349, filed Dec. 13, 2023, which is hereby incorporated by reference wherein in its entirety.

What is claimed is:

1. An optical apparatus comprising:
a barrel member that holds an optical element;
a pressing member that contacts with both the optical element and the barrel member;
a biased member that is fixed to the barrel member; and
an elastic member that is disposed between the pressing member and the biased member in a radial direction and interposed between the biased member and the pressing member in an optical axis direction. 2 The optical apparatus according to claim 1, wherein the pressing member includes a protrusion that protrudes in the radial direction, and
wherein the elastic member is disposed between the biased member and the protrusion in the optical axis direction.

3. The optical apparatus according to claim 2, wherein the protrusion is located inside of the biased member in the optical axis direction and the radial direction.

4. The optical apparatus according to claim 1, wherein a part on a subject side of the pressing member is located outside of the barrel member in the optical axis direction when the pressing member is brought into contact with the optical element and the barrel member.

5. The optical apparatus according to claim 1, wherein the biased member is disposed to include a first area, which is an area outside of the barrel member in the optical axis direction and the radial direction, and a second area which is an area outside of the barrel member in the radial direction. 6 The optical apparatus according to claim 1, wherein the pressing member and the elastic member are sequentially arranged from a subject side of the barrel member, and the biased member is fixed to the barrel member in a state in which the biased member is in contact with the pressing member.

7. The optical apparatus according to claim 1, wherein the biased member is fixed to the barrel member in a state in which the biased member is in contact with a surface on a subject side of the pressing member in the optical axis direction.

8. The optical apparatus according to claim 1, further comprising:
a male screw portion provided in an outer radial portion of the barrel member; and
a female screw portion provided in an inner radial portion of the biased member,
wherein the biased member is fixed to the barrel member in a case where the male screw portion is screwed to the female screw portion.

9. The optical apparatus according to claim 1, wherein the elastic member is a spring member that is formed of a metallic material.

10. The optical apparatus according to claim 1, wherein the barrel member is formed of a metallic material.

11. The optical apparatus according to claim 1, further comprising a sensor holder that holds an image sensor,
wherein the barrel member includes a flange that is fixed to the sensor holder.

12. The optical apparatus according to claim 11, wherein an inner diameter of the elastic member is equal to or less than an outer diameter of the flange.

13. The optical apparatus according to claim 1, further comprising a rotation regulating portion that regulates rotation of the pressing member about an optical axis with respect to the biased member is provided in the pressing member.

14. An imaging apparatus comprising:
the optical apparatus according to claim 1; and
an image sensor that receives light from the optical apparatus.

15. A control system comprising:
the imaging apparatus according to claim 14; and
an acquisition unit configured to acquire distance information of an object based on a signal from the image sensor.

16. The control system according to claim 15, further comprising a control device that controls movement of a movable apparatus based on the distance information.

17. The control system according to claim 15, further comprising a warning device configured to give a warning based on the distance information of the object.

18. A movable apparatus comprising the optical apparatus according to claim 1,
wherein the movable apparatus is configured to move while holding the optical apparatus.

19. A movable apparatus comprising:
the optical apparatus according to claim 1; and
an acquisition unit configured to acquire distance information of an object based on a signal from a light receiving element.

20. The movable apparatus according to claim 19, further comprising a control unit configured to control movement of the movable apparatus based on the distance information.
